(19) United States
(12) Patent Application Publication
(10) Pub. No.: US 2012/0281923 A1
(43) Pub. Date: Nov. 8, 2012

(54) DEVICE, SYSTEM, AND METHOD OF IMAGE PROCESSING UTILIZING NON-UNIFORM IMAGE PATCH RECURRENCE

(75) Inventors: Michal Irani, Rehovot (IL); Maria Zontak, Rehovot (IL)

(73) Assignee: Yeda Research and Development Co., Ltd., Rehovot (IL)

(21) Appl. No.: 13/461,796

(22) Filed: May 2, 2012

Related U.S. Application Data
(60) Provisional application No. 61/481,245, filed on May 2, 2011.

(51) Int. Cl. G06K 9/68

(52) U.S. Cl. 382/218

(57) ABSTRACT

A method of image processing is disclosed, the method implementable on an electronic device, the method comprising: calculating for an image patch within an image at least one patch-dependent content information; based on said at least one patch-dependent content information, determining a patch-dependent search region; searching said patch-dependent search region for one or more image patches that are similar to said image patch; and processing said image patch based on said similar image patches found in said patch-dependent search region.

### PRIOR APPLICATION DATA

This application claims priority and benefit from U.S. application 61/481,245, entitled “Internal Statistical Priors”, filed on May 2, 2011, which is incorporated herein by reference in its entirety.

### FIELD OF THE INVENTION

The present invention relates to the field of image processing.

### BACKGROUND

Many users may capture photographs and images, for example, using a stand-alone digital camera, a digital camera embedded in a cellular phone, a digital camera embedded in a tablet or a handheld device, or an image scanner able to scan photographs and documents.

Some captured images may suffer from image noise (“noise”), such that spurious variations of color or brightness may appear in a captured image even though such variations may not be present in the object imaged. Image noise may result from various factors, for example, long shutter speed, photodiode leakage current, inaccurate color balance processing, insufficient light, image sensor heat, or the like.

Some computerized image editing applications may include filters or algorithms which attempt to partially mitigate image noise by “denoising” an image or by performing image noise reduction. Image denoising is a visual reconstruction problem which may often be under-constrained or ill-possed, and may rely on image priors. Such image priors may range from naive and simple “smoothness” priors, to more sophisticated statistical priors learned from large collections of natural images.

To date, natural image statistics are mostly based on models extensively trained on wide external databases of natural images. For example, parametric models may impose parametric distribution on natural image responses to local filters. The filters and other parameters of these models may be learned using a large database of natural image examples. Although the space of all natural images is sparse, trying to capture its wide variety of features with only a few parameters is extremely difficult or impossible. As a result, the learned models may reduce to the lowest common denominator of all natural images, and the generated image priors may result in unsatisfactory image denoising.

### SUMMARY

The present invention may include, for example, a method, device, and system of image processing, and particularly of image denoising, image super resolution, and other algorithms of image reconstruction or image analysis.

The present invention may include, for example, a method of image processing implementable on an electronic device, the method comprising: calculating for an image patch within an image at least one patch-dependent content information; based on said at least one patch-dependent content information, determining a patch-dependent search region; searching said patch-dependent search region for one or more image patches that are similar to said image patch; and processing said image patch based on said similar image patches found in said patch-dependent search region.

In accordance with the present invention, for example, the patch-dependent search region may include a confined region around said image patch.

In accordance with the present invention, for example, the patch-dependent search region may include an external database of images.

In accordance with the present invention, for example, the patch-dependent search region may include at least one of: a circular region around said image patch, a square region around said image patch, a rectangular region around said image patch, an elliptical region around said image patch, and a polygonal region around said image patch.

In accordance with the present invention, for example, the patch-dependent search region is determined based on pre-computed internal image statistics of natural image patches and said patch-dependent content information.

In accordance with the present invention, for example, the pre-computed internal image statistics quantify a typical property of recurrence of a natural image patch inside a natural image.

In accordance with the present invention, for example, the typical property of recurrence may include at least one of: a rate of decay of recurrence of natural image patches within an image, a density of natural image patches, a degree of occurrence of natural image patches, a number of similar patches to a natural image patch, average behavior of a plurality of natural image patches having similar patch-dependent content information, statistical distribution of natural image patches inside an image, and non-uniform distribution of natural image patches inside an image.

In accordance with the present invention, for example, the typical property of recurrence is quantified by utilizing at least one of: an empirically computed lookup table of said typical property, a parametric expression of said typical property, a polynomial expression of said typical property, an exponential expression of said typical property, and an analytical expression of said typical property.

In accordance with the present invention, for example, determining may include function of at least one of: a spatial distance from said image patch, a spatial directional distance from said image patch, a spatial scale of said image, a complexity of said image patch, content of said image patch, gradients of said image patch, one or more directional derivatives of said image patch, a variance of said image patch, a Laplacian parameter of said image patch, a descriptor of said image patch, a local image descriptor of said image, and a signal-to-noise ratio within said image patch.

In accordance with the present invention, for example, the typical property of recurrence may be a function of at least one of: a spatial distance from said natural image patch, a spatial directional distance from said natural image patch, a spatial scale of said natural image, a complexity of said natural image patch, content of said natural image patch, gradients of said natural image patch, one or more directional derivatives of said natural image patch, a variance of said natural image patch, a Laplacian parameter of said natural image patch, a descriptor of said natural image patch, and a local image descriptor of said natural image.

In accordance with the present invention, for example, the method may include limiting an internal patch-dependent search region, for patches similar to a low-gradient image patch, to a close vicinity of said low-gradient image patch within said image.

In accordance with the present invention, for example, the method may include applying on a low-gradient image patch an internal search within said image for similar patches; and applying on a high-gradient image patch an external search in an external image database for similar patches.

In accordance with the present invention, for example, the method may include: if a gradient content of said image patch is high, then increasing a size of said external image database to be searched in said external search.

In accordance with the present invention, for example, the patch-dependent content information may include at least one of: a mean gradient magnitude of said image patch, a patch variance, a patch descriptor, a SIFT patch descriptor, a local self-similarity patch descriptor, one or more patch colors, distribution of gradients in said image patch, distribution of colors in said image patch, and a signal-to-noise ratio within said image patch.

In accordance with the present invention, for example, the image processing may include performing at least one of: image denoising, super resolution, image summarization, image saliency, image completion, and image retargeting.

In accordance with the present invention, for example, searching said patch-dependent search region for one or more image patches that are similar to said image patch may include: measuring patch similarity by taking into account at least one of: normalized correlation, Lp-norm, mutual information, Sum of Square Differences (SSD), and mean-square-error.

In accordance with the present invention, for example, processing the image patch may include: generating a new image patch from said one or more similar image patches found in said patch-dependent search region; and the image processing may include reconstructing a new image from one or more said generated new image patches.

In accordance with the present invention, for example, generating a new image patch may include at least one of: averaging of a plurality of said similar patches; weighted averaging of a plurality of said similar patches; computing a median of a plurality of said similar patches; performing SVD of a plurality of said similar patches; performing fusion of a plurality of said similar patches; applying an operator to a plurality of said similar patches; and performing Principal Component Analysis (PCA) of a plurality of said similar patches.

In accordance with the present invention, for example, reconstructing a new image may include at least one of: replacing said image patch with said generated new image patch; replacing part of said image patch with part of said generated new image patch; replacing a center pixel of said patch with the center pixel of said generated new image patch; averaging overlapping regions of generated new image patches; and superimposing overlapping regions of generated new image patches.

In accordance with the present invention, for example, the method may be implementable on an electronic device selected from the group consisting of: a desktop computer, a portable computing device, a stand-alone digital camera, a smartphone comprising a digital camera, a cellular phone comprising a digital camera, and an image scanner.

The present invention may provide other and/or additional benefits or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of an image processing application, in accordance with the present invention;

FIG. 2 is a flowchart of a method of image processing, in accordance with the present invention;

FIG. 3A is a schematic illustration demonstrating patch recurrence, in accordance with the present invention;

FIG. 3B is a schematic illustration of a histogram demonstrating patch density as a function of the mean gradient magnitude of the patch and the spatial distance from the patch location, in accordance with the present invention;

FIG. 3C is a schematic illustration of a histogram demonstrating the number of similar patches as a function of the mean gradient magnitude of the patch and the spatial distance from the patch location, in accordance with the present invention;

FIG. 3D is a schematic illustration of a graph demonstrating a linear relation between the log number of Nearest Neighbors (NN) and a scale level, in accordance with the present invention;

FIG. 4 is a schematic illustration of a graph demonstrating the resulting errors of a denoised image relative to a “ground truth” clean image comparing different search regions (local, global, and adaptive), in accordance with the present invention;

FIG. 5 is a schematic illustration of a graph of results of an expressiveness experiment, showing Root Mean Squared Error (RMSE) per patch, as a function of mean gradient magnitude per patch, in accordance with the present invention;

FIG. 6 is a schematic illustration of a graph of internal/external log patch density, as a function of mean gradient magnitude per patch, in accordance with the present invention; and

FIG. 7A is a schematic illustration of a graph of prediction error as a function of mean gradient magnitude per patch, in accordance with the present invention;

FIG. 7B is a schematic illustration of a graph of prediction uncertainty as a function of mean gradient magnitude per patch, in accordance with the present invention;

FIG. 8 is a schematic illustration of a graph of results of an experiment that compares internal denoising and external denoising, the graph showing RMSE per patch as a function of mean gradient magnitude per patch, in accordance with the present invention; and

FIG. 9 is a schematic illustration of a graph demonstrating RMSE and standard deviation per patch as a function of mean gradient magnitude per patch, comparing compacted (K-SVD) and non-compacted (raw) image patches, in accordance with the present invention.

### DETAILED DESCRIPTION OF THE INVENTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Applicants have realized that statistics of natural images may provide useful priors for solving under-constrained, inversion problems in computer vision, and may be particularly useful for computerized image noise reduction or image “denoising”. Applicants have also realized that substantial internal data redundancy within a single natural image (e.g., recurrence of small image patches), may allow generation of powerful internal image-specific statistics, which may be useful for improving any natural image, such as by denoising or other image processing. Accordingly, the present invention may include a parametric quantification of internal statistics which may be averaged over a set of natural images and may be useful in solving under-constrained vision problems, such as image denoising, super-resolution, or the like. In accordance with the present invention, the likelihood of an image patch to recur at another image location may be expressed parametrically as a function of the spatial distance from the patch, and its gradient content, thereby producing an internal parametric prior. The internal parametric prior may then be used by a noise reduction algorithm, a super-resolution algorithm, or the like.

Applicants have further realized that internal image-specific statistics may often be more powerful than general external statistics (e.g., derived from a database of images), thereby allowing generation of useful image-specific priors. Applicants have further realized that image patches tend to recur more frequently (densely) inside the same image, than in any random external collection of natural images.

Although portions of the discussion herein may relate, for demonstrative purposes, to image denoising or image noise reduction, the internal image statistics generated in accordance with the present invention may be utilized in conjunction with other algorithms or applications, for example, texture synthesis, super-resolution, image improvement algorithms, image summarization, image retargeting, image completion, or the like.

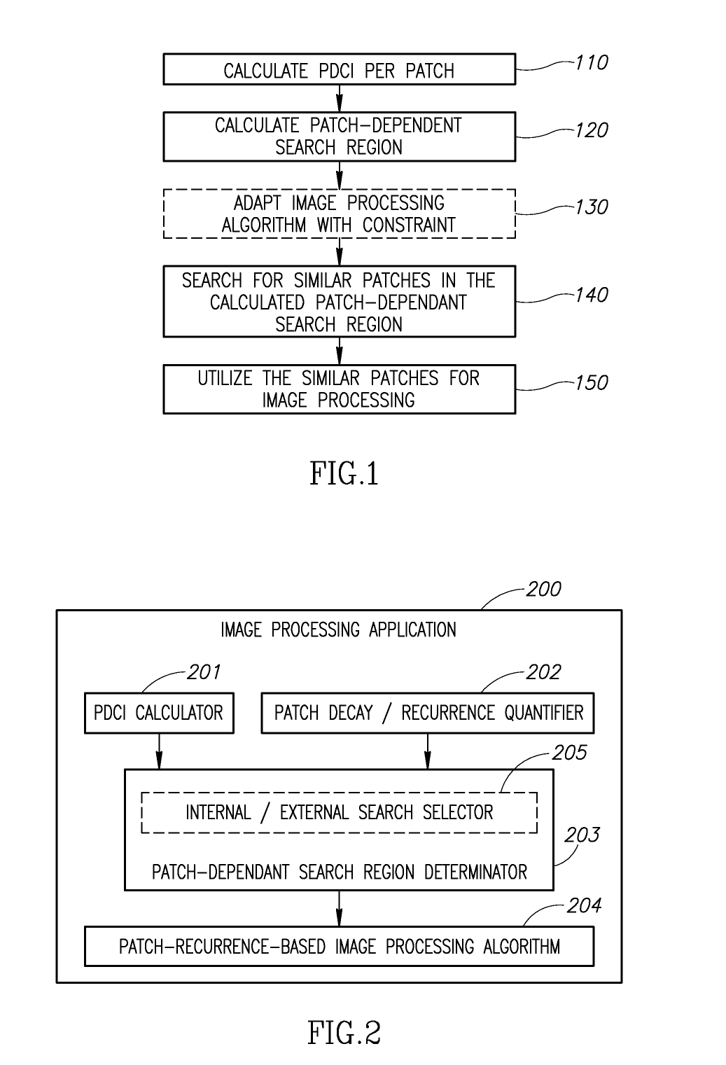

Reference is made to FIG. 1, which is a flowchart of a method of image processing in accordance with some demonstrative embodiments of the present invention. The method may be used, for example, in conjunction with a hardware-based and/or software-based component or module, which may optionally be embedded or integrated in another device or application (e.g., an image processing station or computer, a digital camera, an image processing application, or the like).

The method may include, for example, calculating a Patch-Dependent Content Information (PDCI) element for an image patch of a given image being processed (block 110).

The method may further include, for example, based on the calculated PDCI element, calculating a patch dependent search region for said image patch, in which a search for similar image patches is to be performed (block 120). For example, the search region may be defined as a radius, e.g., measured in pixels around a center or around edges of the image patch, indicating a disk-shaped or circular search region. Other suitable search regions may be defined and used, e.g., an oval, a rectangle, a polygon, or the like. The operations of block 120 may include, for example: determining an internal search region within the image; or, determining that the search region should be the entire image; and/or, determining that the search region should be an external database of images.

The method may optionally include, for example, adapting an image processing algorithm by generating or modifying a constraint based on the calculated PDCI or based on the calculated patch-dependent search region (block 130). The constraint may be or may include, for example, a constraint which further defines or limits or affects the search region for similar patches. Optionally, the constraint may indicate other search-limiting or search-narrowing parameters (e.g., to search for similar patches along edges of the image, or in certain directions within the image). It is noted that the operations of block 130 may be optional, or may be skipped. Furthermore, the previously-made determination of patch-dependent search region may be regarded as a particular example of or as a particular case of generating a constraint for the search for similar patches.

The method may further include, for example, performing a search for similar patches in the calculated patch-dependent search region (e.g., a particular search region within the given image; the entire given image; and/or an external image database) (block 140).

The method may further include, for example, utilizing the similar patches that are found in the search, for one or more image processing purposes or image enhancement purposes (e.g., image denoising, super resolution) (block 150). This may include, for example, utilizing such similar patches “as is” for image denoising or for other image processing purposes; and/or generating an alternative or substitute image patch which may then be used for such image denoising or other image processing purposes.

Other suitable operations may be used in accordance with the present invention. Some operations may be performed in sequence, in parallel, concurrently or during an overlapping time period, or in an order which may be different from the order demonstrated in FIG. 1.

Reference is made to FIG. 2, which is a schematic block diagram illustration of an image processing application 200, in accordance with the present invention. For demonstrative purposes, application 200 may be discussed herein in the context of an image denoising application, although other suitable applications may be used.

Application 200 may include one or more modules or components, for example, a PDCI calculator 201, a patch decay/recurrence quantifier 202, a patch-dependent search region determinator 203, and a patch-recurrence-based image processing algorithm 204.

PDCI calculator 201 may calculate, for an image patch within a given image, at least one Patch-Dependent Content Information (PDCI), or a property of a content of such image patch. In a demonstrative example, the PDCI may indicate, for example, a calculated mean gradient of the image patch, patch variance, patch descriptor (e.g., SIFT, local self-similarity), patch colors, distribution of gradients, distribution of colors, patch-wise signal-to-noise ratio (patch-SNR), or the like.

Patch decay/recurrence quantifier 202 may determine or quantify the typical decay and/or the typical recurrence of an image patch in a natural image, based on a-priory statistics averaged over a set or database of natural images. Patch decay/recurrence quantifier 202 may optionally be implemented by using a look-up table or as one or more of the equations or calculations described herein, for example, equation 3 and/or equation 7 (e.g., demonstrating an average number of “Nearest Neighbors” NN within a distance dist from a given image patch), as described in greater detail herein.

It is noted that in accordance with the present invention, internal image statistics may represent recurrence or density or distribution of image patches inside a single natural image, as averaged over a large number of natural images (e.g., 100 or more natural images), thereby providing an indication of “typical behavior” of an image patch inside a natural image. In contrast, external statistics may attempt to prioritize which patches are most likely to be natural patches in general (e.g., based on observations from a large number of natural images), but may not describe properties of such image patch inside the image of its origin (which internal statistics may do).

Patch-dependent search region determinator 203 may calculate or determine, for a given patch, the suitable or efficient search region (e.g., optionally indicated by a search radius around the patch) within the given image and/or externally to the given image, in which a search for similar image patches is to be conducted. Patch-dependent search region determinator 203 may take into account the PDCI generated by PDCI calculator 201. Patch-dependent search region determinator 203 may utilize one or more of the equations or calculations described herein, for example, equation 3 and/or equation 7, or may take into account output from patch decay/recurrence recurrence quantifier 202. Patch-dependent search region determinator 203 may calculate or determine, for example, a search region within the given image; or, may determine that the search region should be the entire given image; and/or may determine that the search region should include an external image database (e.g., in addition to searching within the given image, or instead of searching within the given image). Optionally, Patch-dependent search region determinator 203 may be implemented by using a sub-unit or sub-module, for example, an internal/external search selector 205, which may determine whether the search should be performed in an external image database and/or internally within the given image, based on the calculated PDCI or based on the output generated by patch decay/recurrence quantifier 202.

Patch-recurrence-based image processing algorithm 204 may include an image processing algorithm which utilizes image patch recurrence. Such algorithm may include, for example, an image denoising algorithm, an image noise reduction algorithm, an image super resolution algorithm, an algorithm for separating one or more transparent layers of said image, an algorithm of fast Approximate Nearest Neighbors (ANN) search, a saliency detection algorithm, an image attention algorithm, an edge detection algorithm, a visual inversion algorithm, an image summarization algorithm, an image completion algorithm, an image retargeting algorithm, or the like.

Optionally, image processing algorithm 204 may include or may utilize one or more algorithms, modules, components, calculations and/or operations described in, for example, U.S. application Ser. No. 13/138,894, titled “Super-Resolution for a Single Signal”, filed on Oct. 18, 2011, published as U.S. application publication 2012/0086850, and/or U.S. application Ser. No. 12/598,450, titled “Bidirectional Similarity of Signals”, filed on May 11, 2008, published as U.S. application publication 2010/0177955, both of which are hereby incorporated by reference in their entirety.

Optionally, image processing application 200 may include other component or modules. For example, an optional constraint generator may be used, in order to modify and/or adapt a constraint of image processing algorithm 204, based on the PDCI generated by PDCI calculator 201. Such constraint may be or may include, for example, a constraint indicating that search should be performed along edges (or along or near certain edges) of the given image, or in particular direction(s) away from or around the given patch, or the like. It is noted that determining the patch-dependent search region may be regarded as the primary or the only constraint; and any other or additional constraints may be regarded as secondary or as optional, or may be skipped or not utilized or not calculated.

It is noted that image processing application 200 may be implemented, for example, as or in a hardware-based component and/or a software-based module of an electronic device or system, which may be or may include, for example, a desktop computer, a server, a laptop computer, a portable computing device, a smartphone, a cellular phone, a dedicated or stand-alone image-processing device or computer, a scanner, a stand-alone digital camera, an electronic device incorporating a digital camera, a processor, a Graphic Processing Unit (GPU), a Central Processing Unit (CPU), a Digital Signal Processor (DSP), or the like. Such electronic device or system may include suitable hardware components and/or software modules, for example, a processor, a memory unit, a storage unit, an input unit, an output unit, an operating system, a power source, or the like.

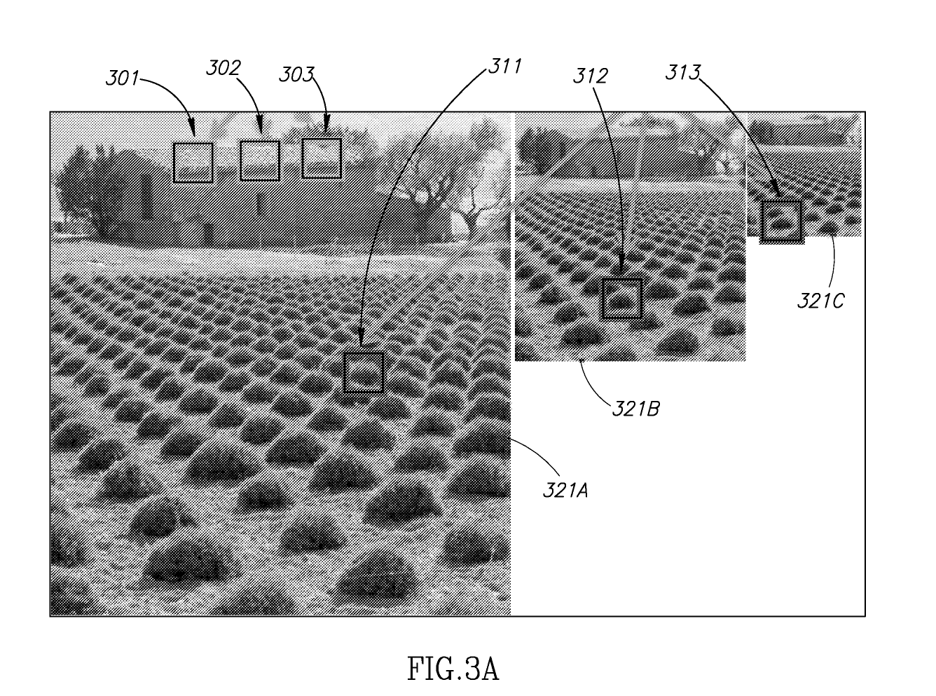

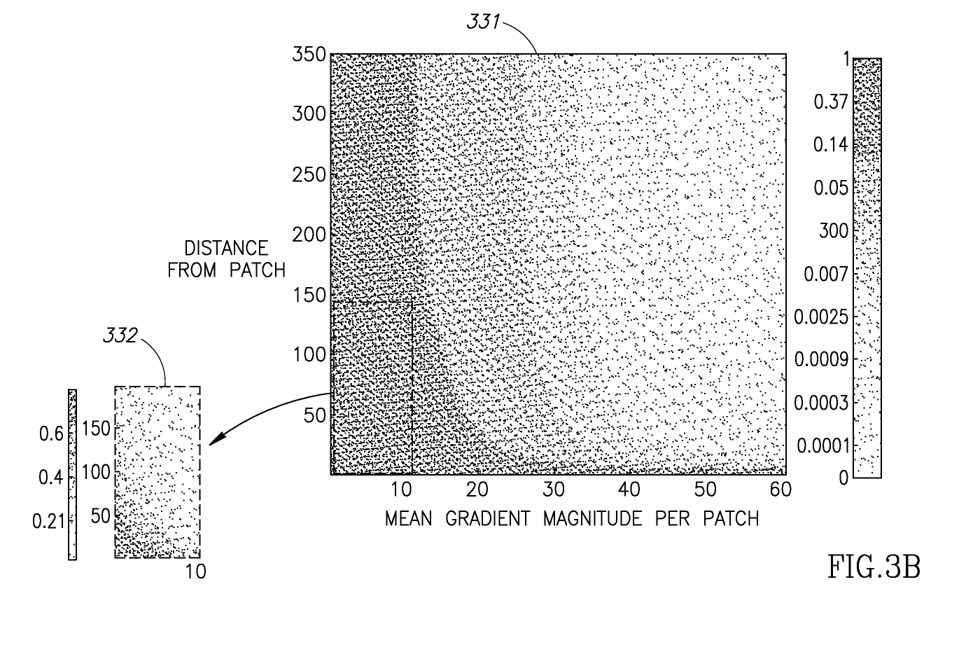

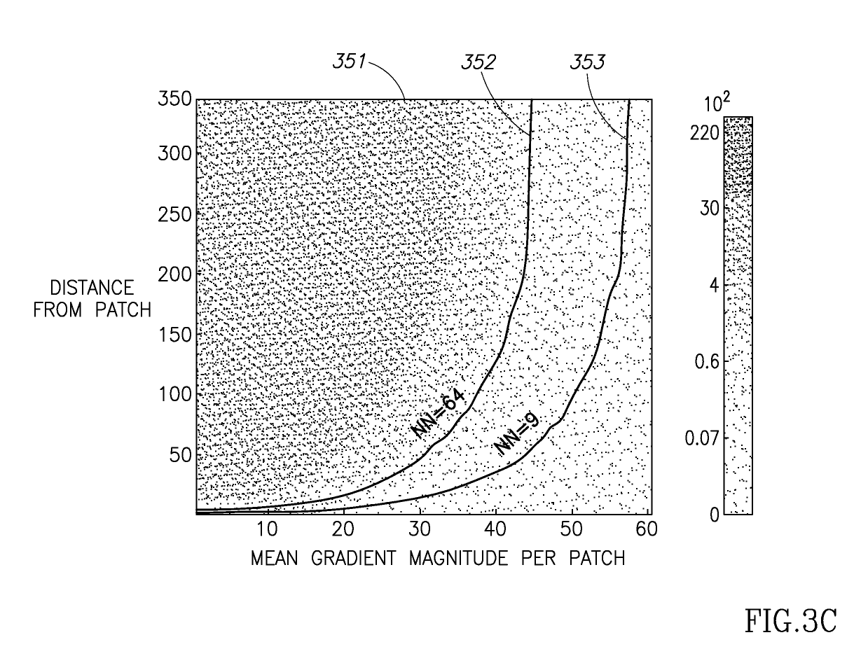

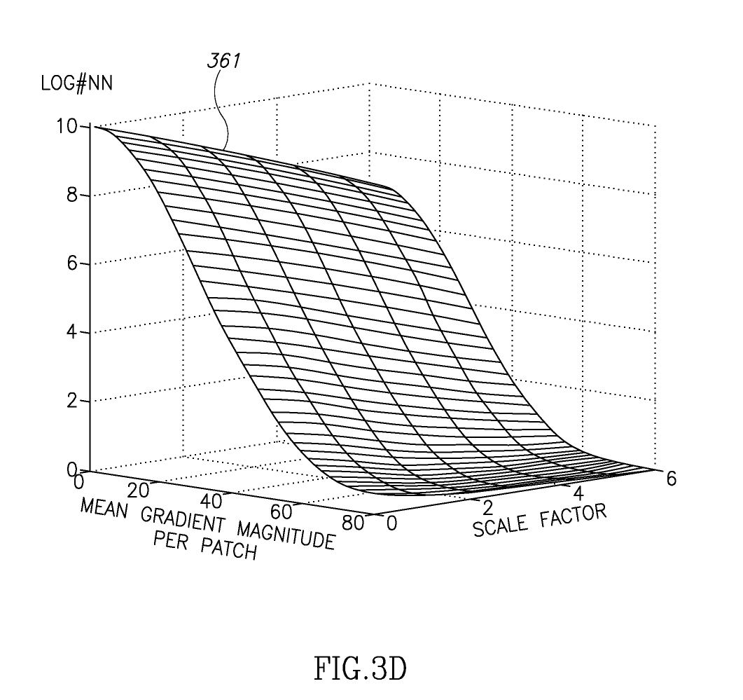

Reference is made to FIGS. 3A-3C to discuss in greater detail how the present invention may parametrically quantify and utilize a degree of recurrence of small image patches. As discussed herein, the patch density may decay (e.g., rapidly) as the spatial distance from the patch location grows, and/or as the patch's gradient content increases. This parametric knowledge may be utilized in image denoising algorithms (e.g., a Non-Local Means (NLM) denoising algorithm) which may thus provide improved image denoising results.

Reference is made to FIG. 3A, which is a schematic illustration demonstrating the notion of patch recurrence within a single natural image shown in three scales 321A, 321B and 321C. For example, a first set of three similar patches 301-303 may be detected within scale; and a second set of three similar patches 311-313 may be detected across scale. For demonstrative purposes, patches 301-303 and 311-313 are shown as large patches and on clearly repetitive structures; however, other sizes or patches may be used, for example, smaller patches (e.g., of approximately 5 by 5 pixels) may be used. When smaller image patches are used, patch repetitions may occur abundantly within and across image scales, even if a user may not visually perceive any obvious repetitive structure in the image. Most of the patches in a natural image may have many similar patches at the same image scale, and at coarser images scales; and the present invention may provide a formal parametric quantification of the degree of internal spatial distribution/recurrence of small patches (e.g., demonstrated with 5 by 5 pixel patches).

Most of the patches in a natural image may be rather smooth, and only a small percent of the patches in a natural image may contain important image details (e.g., edges, corners, or the like). These differences may be expressed in different spatial gradient magnitudes within patches. For example, smooth patches may recur much more frequently in the image than detailed patches; and an image patch may be much more likely to recur near itself than far away. Accordingly, the present invention may determine a “mean gradient magnitude” |grad| of a patch, and a “spatial distance” dist to the patch.

When using a set of 300 natural images, for each image patch p, an empirical density within an image neighborhood [symbol] _{dist} of radius “dist” around the patch may be estimated, for example, using a Parzen window estimation:

density(p; dist)= [symbol] Kₕ(∥p−pᵢ∥₂²/area( [symbol] _{dist}) (1)

In Equation 1, pᵢ may be all the image patches within a spatial neighborhood [symbol] _{dist}, and [symbol] ₕ(•) may be a Gaussian kernel. Averaging these individually-computed patch densities over the set of all patches with the same gradient magnitude” |grad| may produce the following average density:

Density(dist, |grad|)=Meanₚ_{ⱼ}_{of |grad|}density(pⱼ, dist) (2)

The average number of “good Nearest Neighbors” NN within a distance dist from the patch, may be defined as:

NN(dist, |grad|)=Density(dist, |grad|)·area( [symbol] _{dist}) (3)

It is noted that the Parzen estimation may not distinguish, for example, between 10 perfectly similar patches, and 100 partially similar patches. Such 10 perfectly similar patches may be loosely referred to as 10 good NNs.

Reference is made to FIGS. 3B and 3C, which are schematic illustrations demonstrating the empirical density Density(dist,|grad|) and the number of “similar” patches NN(dist,|grad|), respectively, each one as a function of the mean gradient magnitude |grad| of the patch, and the spatial distance dist from the patch location. FIG. 3B shows a main histogram 331 and a zoomed in portion 332, while FIG. 3C shows a histogram 351. In FIGS. 3B and 3C, darker shades of grey indicate high values, whereas lighter shades of grey indicate low values. A vertical axis indicates distance from the patch, and a horizontal axis indicates a mean gradient magnitude per patch.

Observing FIG. 3B it is noted that smooth patches may recur very frequently, whereas highly structured patches recur much less frequently. Given a certain distance, the patch density (recurrence frequency) values diminish from high (darker shades of grey) to low (lighter shades of grey) as we proceed from image patches having low gradient content (left side of the graph) to image patches having high gradient content (right side of the graph).

Furthermore, a patch tends to recur densely in its closest vicinity (small dist), and its frequency of recurrence decays rapidly as the distance from the patch increases. Given a patch with a certain gradient content, a decay in the density may be observed (FIG. 3B) from high values (darker shades of grey) to low values (lighter shades of grey) as we proceed from small search regions (bottom of the graph) to large search regions (top of the graph). In particular, see zoomed-in portion 332 in FIG. 3B, which visualizes this phenomena for relatively smooth patches. Accordingly, patches in a natural image may likely reside in clusters of similar patches. This observation may explain why some denoising algorithms, for example, Non-Local Means or BM3D, may work even though their patch search may be restricted to small neighborhoods around each patch.

Some patch-based applications may require obtaining a sufficient number of similar patches for every image patch. Based on FIG. 3C, it may be noted that for a fixed number of similar patches (NN=const), patches of different gradient content need to search for nearest neighbors at different distances. For smooth patches, it may suffice to search locally, whereas the higher the gradient magnitude, the larger the search region may become. Furthermore, it may be noted that the level-sets in FIG. 3C, which may correspond to a fixed number of Nearest Neighbors, may have exponential shapes; for example, as demonstrated in two curves 352 and 353 which correspond to level-sets of NN=9 and NN=64, respectively. Accordingly, the distance dist in which the nearest neighbor search should be performed may grow exponentially with the gradient content of the patch |grad|. By empirically fitting an exponential function to the level-set curves (for many fixed NNs), the following exponential relation between dist and ‘grad| may be used:

dist(|grad|)=β₁+β₂·exp(|grad|/10) (4)

In Equation 4, the parameters β₁ and β₂ may depend on the fixed NN (e.g., may be second order polynomials of \sqrt{NN}), as follows:

β₁(NN)=5·10⁻³NN+0.09\sqrt{NN}−0.044 (5)

β₂(NN)=7.3·10⁻⁴NN+0.3235\sqrt{NN}−0.35 (6)

The above may be rewritten as:

dist(NN, |grad|)=β₁(NN)+β₂(NN)·e^{|grad|/10} (7)

Equation 7 may provide an explicit parametric expression to determine the search region needed in order to find a desired number of good Nearest Neighbors NNs for a patch. It is noted that this parametric expression may serve as a better statistical prior, for example, in a Non-Local Means denoising algorithm.

It is noted that Equation 7 is quadratic in ·\sqrt{NN}, of the form:

a·\sqrt{NN}²+b·\sqrt{NN}+c=0 (8)

where:

a=0.001·(5+0.73·exp(|grad|/10)) (9)

b=0.1·(0.9+3.24·exp(|grad|/10)) (10)

c=−0.1·(0.44+3.5·exp(|grad|/10)+dist) (11)

Solving for its single valid root yields a closed-form expression of NN as a function of dist and |grad|, as follows:

$$NN ( dist , \vert grad \vert ) = {( \frac{- b + \sqrt{{b}^{2} - 4 ac}}{2 a} )}^{2} \qquad ( 12 )$$

Equation 12 may provide an estimate for the expected number of good Nearest Neighbors that a patch may have within a predetermined region. This parametric expression may provide a good approximation (e.g., up to a mean error of 4%) to the empirical function NN computed using Equation 3 and visually depicted in FIG. 1C. An equivalent expression may be derived for Density(dist,|grad|) of FIG. 1B using Equation 3.

Optionally, statistics of image patch recurrence may be utilized across coarser scales of a natural image. For example, it may be determined that an image patch recurs in another scale, if it appears “as is” (without down-scaling the patch) in a scaled-down version of the image. For each image I, a pyramid of images may be generated, such that the images are of decreasing resolutions {Iₙ}, scaled down by factors of s=0.8ⁿ, n=0, . . . , 6, with I₀=I. For each patch in I, patch recurrence density in I₀, . . . , I₆ (in the entire image) may be measured. The patch recurrence density in I and in its coarser pyramid levels may be approximately the same. The number of Nearest Neighbors decreases in coarser levels, with the decrease in image area:

NN(Iₙ, |grad|)≈s²NN(I, |grad|)=0.8²ⁿNN(I, |grad|) (13)

Equation 13 entails that:

log NN(Iₙ, |grad|)=−0.223n·log NN(I, |grad|) (14)

Equation 14 may correspond to a graph 361 demonstrated in FIG. 3D, which is an example of this linear relation between the log number of Nearest Neighbors (NN) and the scale level n.

The present invention may utilize internal image statistics to improve priors which may then be utilized by image enhancement algorithms (e.g., denoising or noise reduction algorithms). For example, the quantifications presented in Equation 7 may be incorporated into existing or new algorithms which may utilize internal patch redundancy, to improve the results of such algorithm.

Applicants have realized that smooth patches may benefit more from constrained local search, whereas patches with high gradients (e.g., textured patches, patches with edges) may benefit from global search. Incorporating Equation 7 into a Non-Local Means (NLM) denoising algorithm may allow estimating an optimal (or near-optimal) search region per image patch.

In a demonstrative example, a NLM denoising algorithm, which replaces the central pixel in each patch by the mean value obtained from other image patches, weighted by their degree of similarity to the source patch, may be modified using the proposed internal prior (Equation 7). Typically the NLM denoising algorithm works well when the search region is restricted to a local 21×21 search region around each pixel (in accordance with the above-discussed insights of patch density being high within its closest vicinity). Furthermore, the local search may often prove to be preferable over a “global” search in the entire image.

In the above-mentioned demonstrative example, the NLM denoising algorithm has been run on a noisy image by utilizing three different search regions: a search region of 21×21 pixels, a search region of 200×200 pixels, and a search region of the entire image. For each pixel in the image, it was marked which of the three search regions gave it the smallest error relative to the ground-truth clean image. It is noted that smooth patches may benefit more from constrained local search, whereas textured patches with high gradients may benefit from global search. Moreover, applicants have realized that for patches having different mean gradient magnitude, different patch-dependent search regions may be preferred.

In accordance with the present invention, let pₙ=p+n be a noisy version of an image patch p. A measure may be defined, denoted as patch-wise Signal to Noise Ratio (patch-SNR). When p is a smooth patch, the patch-SNR may be low and the noise n may dominate pₙ, inducing new “patterns”. Moreover, although the global mean of the noise is 0, its local mean within small 5×5 patches may often be non-zero, inducing a change in the patch mean. Extending the search region to the entire image may increase the chance of over-fitting the noise, thus preserving effects of the noise n. In contrast, there may be very little chance of finding a good match to the noise pattern in a small neighborhood. Furthermore, the local vicinity of a smooth patch may be sufficient for finding many “correct” Nearest Neighbors (NNs) to the signal p. A local search may thus increase the chance of fitting the “signal” p and not the “noise” n for such patches.

Unlike smooth patches, high-gradient patches may benefit from a large search region. In high-gradient patches, the patch-SNR may be high, and the noisy patch pₙ may be dominated by the signal p. Therefore, a global search in the entire image may not be “risky” for a high-gradient patch. Moreover, the search region may be large in order to find a sufficient number of Nearest Neighbors (NNs) for high-gradient patches.

In accordance with the present invention, this may hold true for natural images in general. In an experimental setting, the NLM denoising algorithm has been applied to many natural images with added Gaussian noise of std σ=15. The NLM denoising algorithm has been applied once locally to a 21×21 search region (e.g., as a “local” NLM), and once globally by using the entire image as a search region (e.g., as a “global” NLM).

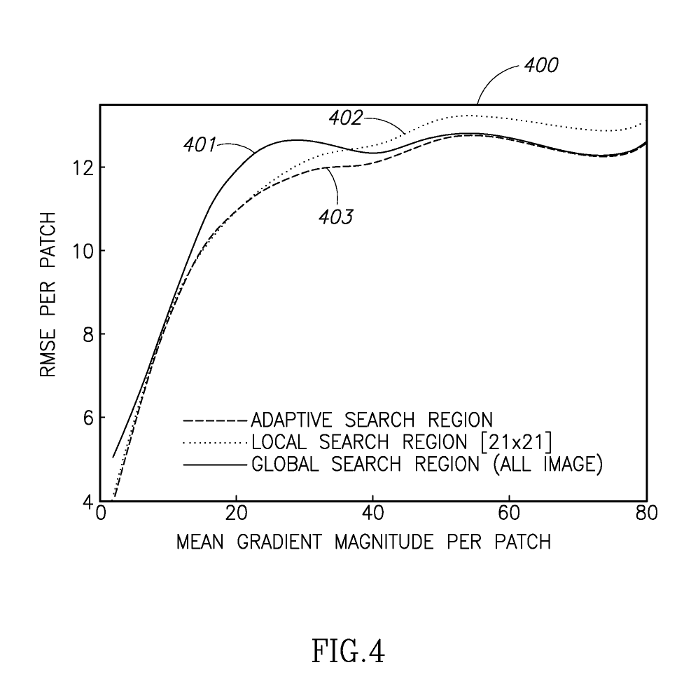

Reference is made to FIG. 4, which is a schematic illustration of a graph 400 demonstrating the resulting errors relative to the “ground truth” clean image (averaged over 100 images). In graph 200, the horizontal axis indicates mean gradient magnitude per patch; and a vertical axis indicates Root Mean Squared Error (RMSE) per patch. A curve 401 indicates the errors produced by a NLM denoising algorithm that utilizes a global search region (e.g., such that the search region equals to the entire image that contains the patch), and demonstrates inferior results for low values of mean gradient magnitude per patch. A curve 402 indicates the errors produced by a NLM denoising algorithm that utilizes a local search region of 21×21 pixels, and demonstrates best results at low values of mean gradient magnitude per patch and inferior results at high values of mean gradient magnitude per patch.

Furthermore incorporating Equation 7 into the NLM denoising algorithm may be used for estimating an “optimal” (or near-optimal, or preferred) search region per patch, yielding improved denoising results. In a demonstrative example, it may be desired to obtain at least k good representatives per patch (to be averaged to recover the clean patch p). Equation 7 may provide an explicit expression for the radius of the search region needed to obtain k Nearest Neighbors (NNs) per patch. The two exponential curves in FIG. 3C demonstrate two such examples, for k=9 and for k=64. In one experiment, a value of k=64 has been used (it is noted that for |grad|>40, the search region may already be the entire image).

Optionally, when handling noisy patches, their “clean” gradient content may be estimated or approximated by using the following calculation:

|grad|ₚ²=|grad|ₚ_{ₙ}²−σₙₒᵢₛₑ (15)

The above holds true since n (the noise in the patch) and p (the clean patch) are independent, and therefore the variance of the noisy patch, pₙ, is the sum of their variances. It has been experimentally found that for patches with |grad|<50, their gradient content may linearly relate to their variances. Similarly, the calculation of the search region may be based on, or may take into account, the variance of the patch. For example, the following equation may be used:

varₚ=varₚₙ−varₙₒᵢₛₑ (16)

where varₙₒᵢₛₑ=σ²ₙₒᵢₛₑ

Referring again to FIG. 4, demonstrated are the resulting NLM values after incorporating the adaptive search region based on Equation 7. This may provide improved results with respect to both “local” NLM and “global” NLM. A curve 403 indicates the errors produced by a NLM denoising algorithm that utilizes an adaptive search region, and demonstrates best results for substantially all values of mean gradient magnitude per patch. Accordingly, incorporating quantitative knowledge about internal image statistics may improve existing or new algorithms that may rely on such statistics.

Utilization of internal image statistics may have advantages in terms of lower memory and computation demands. Furthermore, the internal image-specific statistics may often be more powerful than general external image statistics. A demonstrative example compared these two types of statistics according to their degree of “expressiveness” and “predictive power” (as defined herein). The internal statistics of an image is based on the collection of all the patches extracted from the image and its multi-scale versions. The external statistics is based on all the patches extracted from a general (non class-specific) database of different natural images, the size of the external database ranging from 5 images (small database) to 200 or more images (large database).

“Expressiveness” may be defined as measuring the degree of similarity of a 5×5 patch to its most similar patches found internally versus externally. Internally, the patch itself and its immediate local vicinity are excluded from a search. The L₂ distance may be calculated between two patches, after removing their mean intensity value (DC) (or optionally, without removing their DC, and in such case the advantage of using internal statistics over external statistics may be even more pronounced). Multiple “improved” (output) images has been generated based on an input image, by replacing each patch in the input image with its most similar patch, either from an external database of images (e.g., of 5 images, of 40 images, and of 200 images), or from the image itself and its multi-scale versions. Smooth patches may be found quite easily in an external database, as well as in the image itself. However, this may not hold true for detailed patches (e.g., edges or corners), which may require as many as 200 images to find equally good external representatives to those found internally.

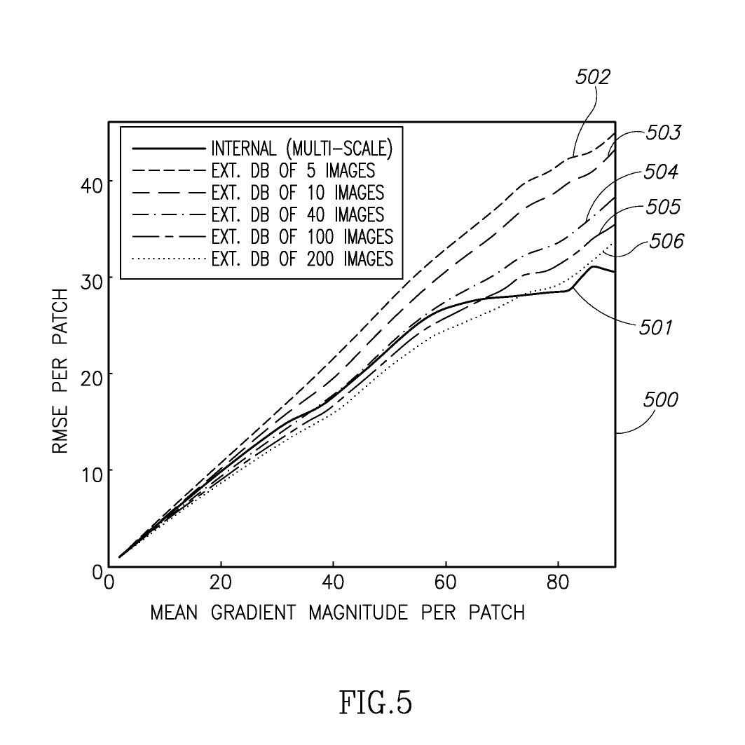

Reference is made to FIG. 5, which is a schematic illustration of a graph 500 demonstrating a similar analysis, empirically conducted over hundreds of images covering more than 15 million 5×5 patches. Errors were computed separately for each gradient magnitude (using RMSE), averaged over all patches with the same gradient magnitude). In graph 500, a horizontal axis indicates mean gradient magnitude per patch; and a vertical axis indicates RMSE per patch. Graph 500 includes a line 501 corresponding to results of using an internal multi-scale search; and lines 502-506 corresponding to results of using an external search with a database having 5 images, 10 images, 40 images, 100 images, and 200 images, respectively. For small external databases (e.g., up to 40 images), only relatively smooth patches (|grad|<20) may be similarly represented internally and externally. However, patches with higher gradient content may require external databases of hundreds of images in order to obtain an external patch of similar quality to the one found internally.

It is noted that a user may fail to reach the above-mentioned insights by computing the mean error averaged over the entire image (which is a widely used measure for evaluating algorithms). More than 80 percent of the patches in natural images tend to have low mean gradient magnitude (≦20). Therefore, any averaging process that does not take into account the uneven distribution of gradient magnitudes, may be governed by the errors in the smooth/undetailed regions of the image. Thus, damages in the most important fine details of the image may not be reflected in a global RMSE measure.

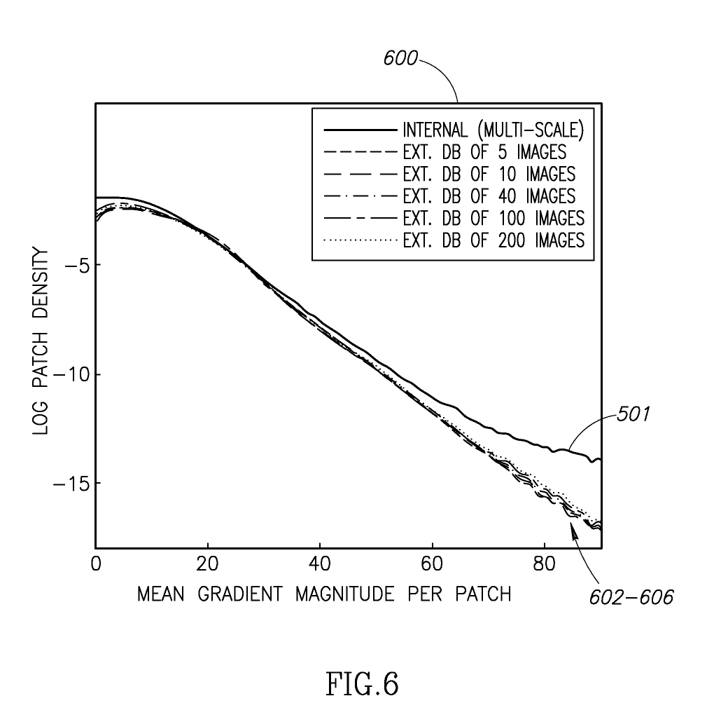

Further compared was the density of patch recurrence, external versus internal. Reference is made to FIG. 6, which is a schematic illustration of a graph 600 that demonstrates that image patches tend to recur much more frequently inside their own image than in any external random collection of natural images, regardless of its size (patch density is displayed in log scale values). This may hold true particularly for highly detailed patches, which may often be the most important ones. In graph 600, a horizontal axis indicates mean gradient magnitude per patch; and a vertical axis indicates log patch density. Graph 600 includes a line 601 corresponding to results of using an internal multi-scale search; and lines 602-606 (which have overlapping or near-overlapping portions) corresponding to results of using an external search with a database having 5 images, 10 images, 40 images, 100 images, and 200 images, respectively.

Statistical priors may be used to constrain ill-posed problems in computer vision. The quality of a prior may be determined by how well it predicts the “correct” solution among the infinitely many possible solutions of the under-determined problem. Applicants have compared compare the “predictive power” of internal image statistics external statistics, when the same prediction method is applied to both types of statistics. An example test case was performed utilizing an ill-posed problem of Super-Resolution (SR) (e.g., image upsampling), with a prediction method of “Example-based Super-Resolution”.

In Example-Based SR, a database of “examples” of high-resolution/low-resolution pairs of image patches {(hᵢ,lᵢ)}ᵢ₌₁ⁿ is provided (e.g., with a relative scale factor of 2). Given an input image L, its high-resolution (upsampled) version H is generated (“hallucinated”), by using the example pairs as “predictors” (priors) on how to upsample the low-resolution patches of L. This may yield the most likely high-resolution image H of L, given the database of examples (predictors). In order to compare the predictive power of internal image statistics versus external statistics in the above setting, the following experiment has been performed (repeated for 100 natural images): Given a natural image I (the “ground truth” high-resolution image, denoted also as H_{GT}), the natural image I was downscaled to half its original resolution, to generate the low-resolution input L. An external database of high-resolution/low-resolution examples was generated was generated from 200 natural images of an external database. An internal database of high-resolution/low-resolution examples was generated from L and its down-scaled versions. The high-resolution/low-resolution pairs were generated both internally and externally by downscaling the available images by a factor of 2:1, and extracting all the corresponding pairs of patches from the two scales.

It is noted that an immediate disadvantage has been detected, due to the fact that the “internal image” L is ¼ of the size (area) of any individual external image. A ratio of 1:200 between the internal/external number of images thus translates to an actual ratio of 1:800 in the number of examples to learn from (the high-resolution/low-resolution pairs of patches). Therefore, added to the internal database were rotated versions of L (at ±45 degrees), thereby increasing the space of internal pairs of patches back to its original internal/external ratio.

For every 5×5 patch, l∈L, the experiment searched for its k=9 low-resolution Nearest-Neighbors {l_{i}}ᵢ₌₁^{k} in the internal/external databases. Their corresponding high-resolution patches, {hᵢ}ᵢ₌₁^{k}, which serve as individual predictors, were averaged to recover the overall high-res estimate ĥ of l:

$$\hat{h} = \frac{{\sum }_{i} {w}_{i} \cdot {h}_{i}}{{\sum }_{i} {w}_{i}} \qquad ( 17 )$$

In Equation 16,

$${w}_{i} = {exp}^{-} \frac{{‖ l - {l}_{i} ‖}_{2}^{2}}{2 {σ}^{2}} \qquad ( 18 )$$

For each high-res ground truth patch, h_{GT}, two parameters were measured. The first parameter measured was a Prediction Error parameter, calculated as:

Prediction Error=∥h_{GT}−ĥ∥₂² (19)

The second parameter measured was a Prediction Uncertainty parameter, corresponding to the weighted variance of the predictors {hᵢ}ᵢ₌₁^{k}, which may be approximated using trace (Cov_{W}(hᵢ,hⱼ)) (with the same weights as above). The Prediction Uncertainty parameter may serve as a reliability measure of the prediction. The high-resolution predictors, {hᵢ}ᵢ₌₁^{k}, should not only be individually close to the true h_{GT} (low prediction error), but should also be mutually consistent with each other (low uncertainty). High uncertainty (entropy) among all the high-resolution candidates {hᵢ}ᵢ₌₁^{k}, of a given low-resolution patch l, may indicate high ambiguity in the predicted high-resolution patch, which may result in visual artifacts, for example, “hallucinations” and blurring (e.g., due to multiple inconsistent high-resolution interpretations).

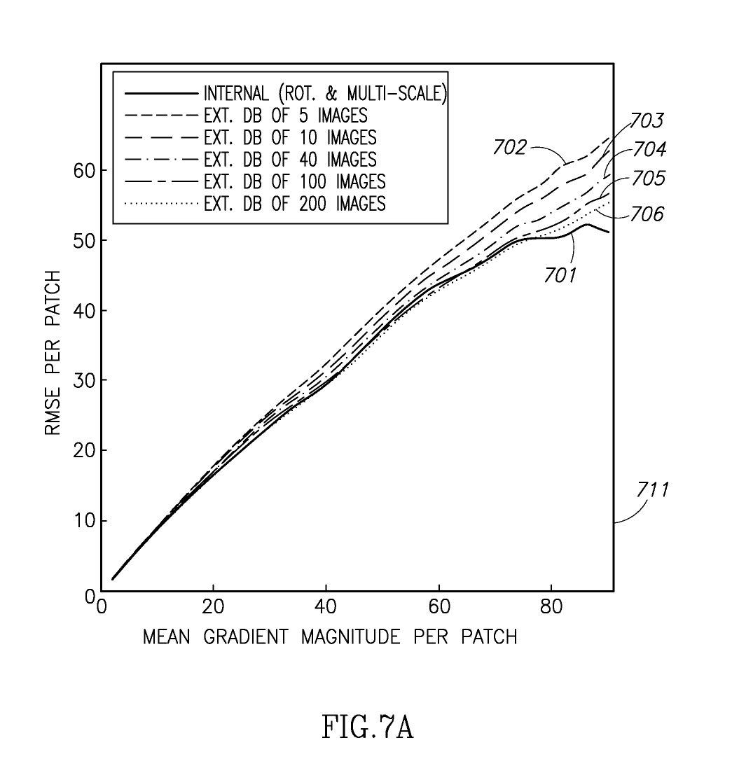

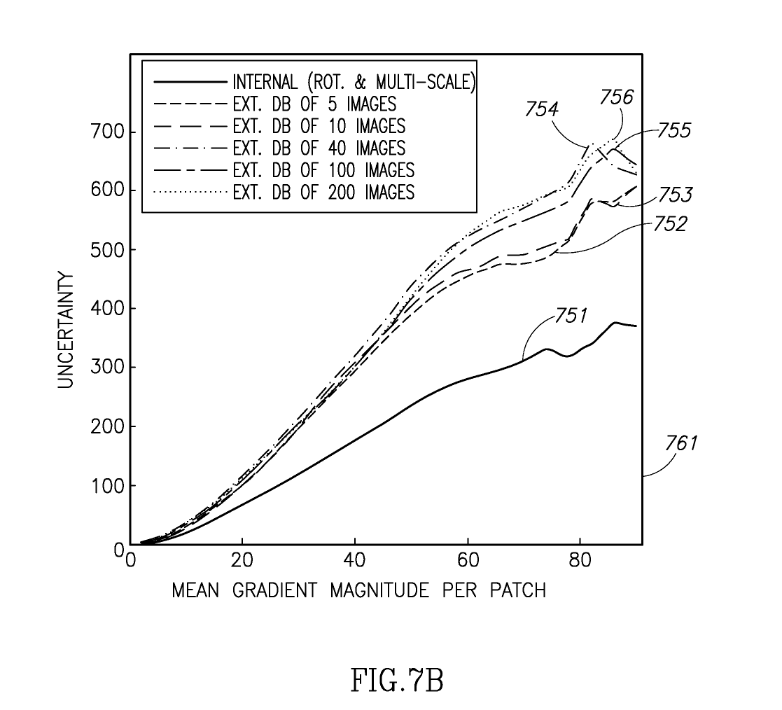

FIGS. 7A and 7B demonstrate the statistics of the Prediction Error parameter (FIG. 7A) and the Prediction Uncertainty parameter (FIG. 7B), respectively, each parameter averaged over all the patches from 100 natural images. FIG. 7A is a schematic illustration of a graph 711 demonstrating prediction error as a function of mean gradient magnitude per patch. In graph 711, a horizontal axis indicates mean gradient magnitude per patch; and a vertical axis indicates RMSE per patch. Graph 711 includes a line 701 corresponding to results of using an internal multi-scale search (including multi-scales of the rotations of the original image); and lines 702-706 corresponding to (inferior) results of using an external search with a database having 5 images, 10 images, 40 images, 100 images, and 200 images, respectively. Similarly, FIG. 7B is a schematic illustration of a graph 761 demonstrating prediction uncertainty as a function of mean gradient magnitude per patch. In graph 761, a horizontal axis indicates mean gradient magnitude per patch; and a vertical axis indicates the prediction uncertainty. Graph 761 includes a line 751 corresponding to results of using an internal (rotated) multi-scale search; and lines 752-756 corresponding to (inferior) results of using an external search with a database having 5 images, 10 images, 40 images, 100 images, and 200 images, respectively.

It is noted that it may require hundreds of external images to achieve external prediction error similar to the internal prediction error. Moreover, in the high gradient patches, the internal prediction error is still lower than the external error, even for large external databases. Although these patches are relatively sparse in the image, these may be the most critical patches in Super-Resolution (e.g., the edges, corners, and high-detailed image parts); and this is where the increase in resolution is observed.

Moreover, the Prediction Uncertainty is much higher externally than internally (for any database size), indicating that general external statistics are more prone to “hallucinations” than internal image-specific statistics. Experiments showed that example-based prediction, utilizing an external database of 200 general images, produces inferior results which include hallucination of details and more blurriness.

It is noted that utilization of a “huge” external database (e.g., millions of billions of images from a database or from the Internet) for generation of external statistics may not be better than utilizing internal image statistics. Firstly, as demonstrated in FIG. 5B, larger external databases exhibit lower predictive power (higher uncertainty). Secondly, high gradient patches (which are the most informative ones) are rare and have very low density in an external database, regardless of its size. High gradient patches may not be captured well by any compact quantized representation (e.g., K-SVD or PCA). Thus, finding such high gradient patches in a huge external database requires an extensive search, which may be computationally infeasible for a practical application. In contrast, internally within an image, high gradient patches have sufficiently good Nearest-Neighbors (comparable to hundreds of external images), and their search space is limited to a single image (and even better, to the patch local vicinity).

The inefficiency of utilizing a huge external image database, relative to using internal image statistics, was confirmed in an experiment which performed image denoising. In an experiment, the NLM denoising algorithm was utilized, one time using internal (noisy) patches, and one time using an external database of clean images (averaging over similar external patches). In principal, increasing the number of clean patches in the external database may improve the denoising results (e.g.,denoising using 300 external images yields cleaner results than denoising using 3 external images). However, with 300 images, the external denoising result was still inferior to internal denoising result. Moreover, the external denoising process required an enormous run-time of four days (on a Linux 2668 MHz computer), versus a half-minute run-time for the internal denoising.

It is noted that an attempt was made to reduce the external denoising run-time: for each patch in the noisy image, its external averaging was limited to only 1,000 external Nearest Neighbors (using KD-tree). The reduced run-times remained relatively high, but what is more important is that the limited NN-search induced a new problem, such that enlarging the external database (e.g., from 3 images to 300 images) yielded inferior (noisier) results. This may be due to over-fitting the noise in smooth image patches (e.g., as may also occur in global-NLM denoising). While denoising of the detailed (infrequent) patches may improve as the database size grows, denoising of smooth patches (the majority) may become worse. It is noted that in accordance with the present invention, it may be advantageous to utilize an external database as the search region for finding similar patches to a high-gradient patch; whereas for a low-gradient patch it may be advantageous to perform a local search (e.g., in within a circular area or other confined area around or near the given patch).

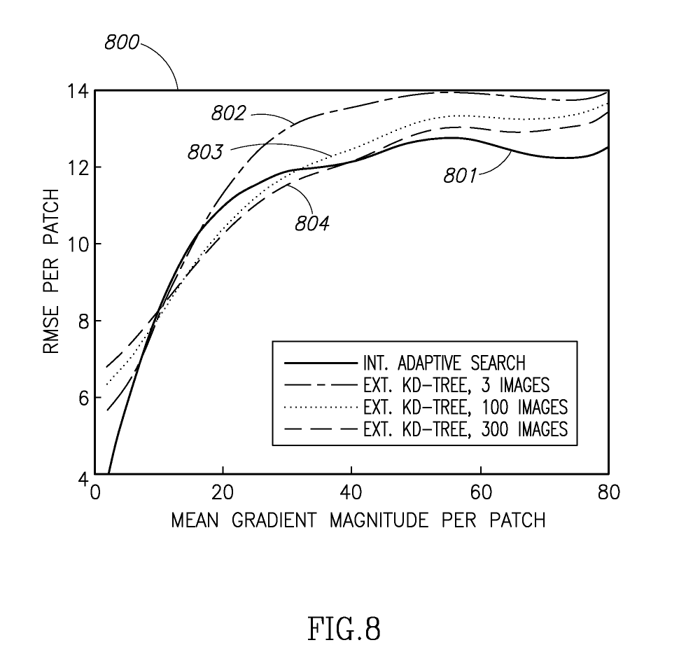

As demonstrated in FIG. 8, this holds in general for many natural images (contaminated by Gaussian noise with std=15). FIG. 8 is a schematic illustration of a graph 800 demonstrating RMSE per patch as a function of mean gradient magnitude per patch. In graph 800, a horizontal axis indicates mean gradient magnitude per patch; and a vertical axis indicates the RMSE per patch. To produce graph 800, data was averaged in an experiment over 100 natural images. Graph 800 includes a line 801 corresponding to results of using an internal adaptive search; and lines 802-804 corresponding to (inferior) results of using an external search (which utilized KD-tree) with a database utilizing 3 images, 100 images, and 300 images, respectively.

It is noted that the denoising results become worse for smooth patches as the size of the external database is increased. Therefore, utilizing a huge external database may only yield worse (noisier) results, for smooth patches. Unlike super-resolution, in image-denoising the smooth patches are the most important ones, as this is where the noise is most visible; thus, global PSNR may be an adequate measure in denoising (e.g., such that larger dB is better).

Compact representations, which take advantage of redundancy of patches within an image, may not capture well the full richness of single-image statistics, and may even harm the most informative (detailed) patches in the image. When image descriptors (e.g., SIFT) are divided into fine bins, the bin-density follows a power-law (i.e., “long-tail” or “heavy-tail” distribution). The long-tail behavior holds also for image patches. This results from the fact that many different high-gradient image patches have very low density, such that each of them recurs rarely in the image. These high-gradient patches are found in low-density regions in the space of all image patches, rather isolated. Namely, there are almost no clusters around these patches. Any quantization/clustering process applied to obtain a compact representation, may represent well the most frequent clusterable elements (smoother patches), whereas the infrequent/unclusterable elements (high-gradient patches) may suffer from high quantization errors. This property may exist in long-tailed distributions independently of the clustering/quantization method being used.

In an experiment, each image patch was represented in two ways. One type of image representation utilized K-SVD, such that every patch is represented as a linear combination of three elements from a 256-element K-SVD dictionary built from 5×5 patches of the image, plus the mean intensity value (DC) of the patch. The second type of image representation was raw image patches, namely, a linear combination of three other patches in the same image (no multi-scale), plus the patch DC. The experiment showed that the quantization error induced by K-SVD dominates in the detailed parts of the image, and is significantly higher than when using raw image patches. This finding holds in general for natural images, based on statistics accumulated over 300 natural images.

It is noted that adding those badly represented patches to the compact representation may eliminate its compactness. For example, given a 256×256 image (65,536 bytes) and a K-SVD dictionary of 256 elements of 5×5 (6,400 bytes), the initial saving in storage space may be approximately 1/10. Assuming that the 3% most isolated image patches (that are poorly represented by K-SVD) are added, this translates to adding 3%·256²·5²=49,152 bytes (which almost the original image size). In other words, patches are already represented compactly in the image itself (due to their built-in overlaps with each other), providing the full richness of all image patches. Moreover, the raw image preserves geometric information of where to look for similar patches, while this information is lost in compact representations.

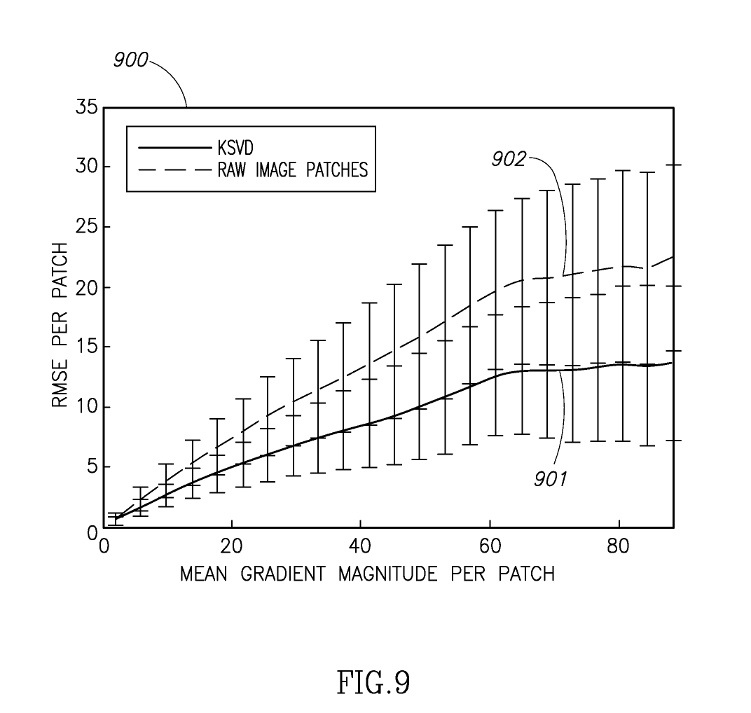

Reference is made to FIG. 9, which is a schematic illustration of a graph 900 demonstrating RMSE and standard deviation per patch as a function of mean gradient magnitude per patch, comparing compacted (K-SVD) and non-compacted (raw) image patches. In graph 900, a horizontal axis indicates mean gradient magnitude per patch; and a vertical axis indicates the RMSE per patch. To produce graph 900, data was averaged in an experiment over 300 natural images. Graph 900 includes a line 901 corresponding to results of using “raw” (non-compacted) image patches; and a line 902 corresponding to (inferior) results of using K-SVD image patches.

The equations and insights discussed above may be generalized and/or utilized in various ways and applications. For example, instead of using gradient content within a patch, other types of Patch-Dependent Content Information (PDCI or “patch content”) may be utilized, e.g., variance within a patch (of intensities or colors), directional derivatives within a patch, magnitude or any function of a descriptor computed within a patch (e.g., SIFT, shape context, Self-Similarity), patch colors, distribution of gradients, distribution of colors, patch-wise signal-to-noise ratio (patch-SNR), or the like. Utilization of a guided and/or adaptive search region based on the PDCI content may significantly improve many ill-constrained or ill-posed computer vision algorithms (e.g., image reconstruction, image inversion, image recognition, image denoising, super resolution, image completion, image retargeting) that use patch redundancy. Furthermore, the guided search regions may be generalized from isotropic to non-isotropic (directional) search regions.

The functions and parametric statistical priors discussed above (e.g., average density and average number of NNs for each patch) may be computed as a function of distance and the mean gradient magnitude. Optionally, such typical properties of recurrence of an image patch within a single natural image may be a function of at least one of: a spatial distance from a natural image patch, a spatial directional distance from a natural image patch, a spatial scale of a natural image, a complexity of a natural image patch, content of a natural image patch, gradients of a natural image patch, one or more directional derivatives of a natural image patch, a variance of a natural image patch, a Laplacian parameter of a natural image patch, a descriptor of a natural image patch, and/or a local image descriptor of a natural image. Other suitable parameters may be used.

In accordance with the present invention, a patch-dependent search region may be determined based on pre-computed internal image statistics of natural image patches and based on patch-dependent content information. The pre-computed internal image statistics may quantify a typical property of recurrence of a natural image patch inside a natural image (e.g., as averaged over a large number of natural images). The typical property of recurrence may include, for example: a rate of decay of recurrence of natural image patches within an image; a density of natural image patches; a degree of occurrence of natural image patches; a number of similar patches to a natural image patch; average behavior of a plurality of natural image patches having similar patch-dependent content information; statistical distribution of natural image patches inside an image; and/or non-uniform distribution of natural image patches inside an image.

The typical property of recurrence may be quantified by utilizing at least one of the following: an empirically computed lookup table of the typical property; a parametric expression of the typical property; a polynomial expression of the typical property; an exponential expression of the typical property; and/or an analytical expression of the typical property.

The determination of the patch-dependent search region, and/or the typical property of recurrence, may be a function of one or more of the following parameters: a spatial distance from the image patch; a spatial directional distance from the image patch; a spatial scale of the image; a complexity of the image patch; a content of the image patch; gradients of the image patch; one or more directional derivatives of the image patch; a variance of the image patch; a Laplacian parameter of the image patch; a descriptor of the image patch; a local image descriptor of the image; and/or a signal-to-noise ratio within the image patch.

The parametric priors may be estimated isotropically, for disks of radius “dist”. However, similar parametric priors (and possible even better) may be computed in a non-isotropic way, using directional patch information (e.g., directional derivatives). Instead of computing an isotropic distance as a function of the mean gradient magnitude in a patch, it may be possible to compute a directional function (density or NN) which depends on the derivative magnitudes in that direction. For example, patches of edges may find many nearby NNs along the edge (in the direction of low directional derivative), whereas they are likely to have very few NNs in the direction perpendicular to the edge (in the direction of high directional derivative). Therefore, for each patch, an algorithm may compute the directional derivatives in a few discrete directions (e.g., 8 directions), and may compute the density and NNs as a function of the distance along a segment of the disk in that direction. These functions may be computed separately for each of the 8 direction (e.g., based on statistics accumulated over hundreds of natural images), or, may also be averaged across all 8 directions. Furthermore, an algorithm may also look at other divisions of the gradient content, for example, the major direction and minor direction.

In accordance with the present invention, the calculated patch-dependent content information may include or may reflect one or more parameters or information items, for example, a mean gradient magnitude of the image patch, a patch variance, a SIFT patch descriptor, a local self-similarity patch descriptor, other suitable patch descriptor, one or more patch colors, distribution of gradients in the image patch, distribution of colors in the image patch, and/or patch-wise signal-to-noise ratio (patch-SNR).

In accordance with the present invention, determining the patch-dependent search region may be based on statistical distribution of patches of natural images, and may be used for various image processing purposes, for example, image denoising, super resolution, image summarization, image completion, image retargeting, image reconstruction, image enhancement, or the like.

In accordance with the present invention, searching the patch-dependent search region for one or more image patches that are similar to the image patch may include, for example, measuring patch similarity by taking into account at least one of: normalized correlation, Lp-norm, mutual information, Sum of Square Differences (SSD), and/or mean squared error. Other suitable similarity measurement methods may be used.

Optionally, image processing may include generating of a new image patch from the one or more similar image patches found in the patch-dependent search region; and reconstructing a new image from one or more generated new image patches. For example, generating the new image patch may include at least one of: averaging of a plurality of similar patches; weighted averaging of a plurality of similar patches; computing a median of a plurality of similar patches; computing or performing SVD of a plurality of similar patches; performing fusion of a plurality of similar patches; applying an operator to a plurality of similar patches; and/or performing Principal Component Analysis (PCA) of a plurality of similar patches. The image processing may further include, for example, replacing the image patch with a generated new image patch; replacing a center pixel of the generated new image patch; averaging overlapping regions of generated new image patches; replacing a part of the image patch with a part of generated new image patch, and/or superimposing overlapping regions of generated new image patches. Other suitable operations may be used.

The above-discussed insights on how patch repetitions may be internally distributed within a single natural image may be incorporated as prior information to improve existing or new image reconstruction or image inversion algorithms. This may improve their performance quality-wise and/or computation-wise and/or memory-wise. This approach may be useful both for improving the quality and speed of existing algorithms that employ internal repetitions of patches (but do so in a “blind” way), as well as for developing new algorithms. Such algorithms may include, for example, image denoising, super-resolution, edge detection, Approximate Nearest Neighbor (ANN) search, image recognition, saliency, image compression, image summarization, image retargeting, image completion, or the like.

In a first demonstrative example, a hybrid internal/external denoising algorithm may be constructed. The denoising algorithm need not be limited to internal denoising only, or to external denoising only. Rather, the denoising algorithm may mix internal and external denoising in order to obtain better performance (quality-wise and/or computation-wise) than any individual type of denoising by itself. The choice of external or internal search may be based on the PDCI (patch content). For example, for low-gradient patches (e.g., patches with low patch-wise SNR, that are prone to over-fitting the noise), internal local denoising may be used. Whereas for higher-gradient patches (patches with higher SNR), external denoising may be used with a fast ANN search of similar patches in an external database. Alternatively, an application may utilize a continuum of external databases of varying sizes, according to the patch content; for example, the higher the gradient content of the patch, the larger the external database to be used. This approach may maintain computational efficiency, while increasing the likelihood of fitting the signal, and not the noise.

In a second demonstrative example, a super-resolution algorithm may be constructed. Patch redundancy within different scales of an image may already be utilized in some conventional super-resolution algorithms, which require searching for similar patches to a given patch (that needs to be super-resolved). In some conventional super-resolution algorithms, this search was performed globally (e.g., entire image) within different scales of an image, or alternatively, the search was performed locally (e.g., in the same location in different scales). Both of these conventional approaches have disadvantages: The global search is sensitive to noise-fitting (e.g., search in larger area is more prone to over-fitting JPEG artifacts), while the local search may not take advantage of the information that exist in the other locations of the image at different scales. In accordance with the present invention, a super-resolution algorithm may incorporate adaptive search that depends on the patch content. Low-gradient patches are likely to have enough neighbors within their close neighborhood (in the input scale as well as in coarser image scales), but on the other hand may be globally prone to noise-fitting. Therefore, limiting the search to the closest vicinity of low-gradient patches (at multiple scales) may increase the likelihood of fitting the signal and not the noise. For high-gradient patches, the super-resolution algorithm may search in larger image regions (at multiple scales) in order to benefit from the possible information that may exist there, since high-gradient patches are less prone to noise-fitting.

In a third demonstrative example, an algorithm may utilize guided search for similar patches within an image (e.g., efficient Approximated Nearest Neighbor (ANN) search). Knowledge of the likelihood of patch recurrence based on the patch content may be used to improve ANN search. An adaptive search region (either isotropic or directional) may be utilized, based on the patch content, thus increasing the likelihood of finding good NNs within a limited or required computational time. For example, for low-gradient patches a local search region may suffice; whereas higher-gradient patches may require larger search regions. Similarly, a patch that contains an edge is likely to have more NNs along the edge direction than perpendicular to the edge direction within its local vicinity. These insights may be incorporated in order to construct a more efficient ANN search algorithm.

The present invention may include various other types of image processing algorithms, which may be adapted or constructed to utilize knowledge of typical non-uniform distribution of image patches internally within an image to constrain a solution intended to be achieved by such image processing algorithm. The knowledge of typical non-uniform distribution of image patches may include, for example, knowledge which may be a function of at least one of: a spatial distance from the image patch, a spatial directional distance from the image patch, a spatial scale of the image, a complexity of the image patch, content of the image patch, gradients of the image patch, one or more directional derivatives of the image patch, a variance of the image patch, a Laplacian parameter of the image patch, a descriptor of the image patch, a local image descriptor of the image. The function may be, for example, a function that utilizes one or more parametric priors, a function calculating a density of patch recurrence within the image, a function calculating a number of similar image patches within the image, a function calculating a rate of patch changes within the image, a function calculating a form of patch changes within the image, a decaying function calculating decay of the image patch within the image, an exponential function related to the image patch.

The present invention may be utilized in conjunction with image processing algorithms such as, for example, an image denoising algorithm, an image noise reduction algorithm, an image enhancement algorithm, an image improvement algorithm, an image super resolution algorithm, an algorithm for separating one or more transparent layers of said image, an algorithm of fast Approximate Nearest Neighbors (ANN) search, a saliency detection algorithm, an image attention algorithm, an edge detection algorithm, a visual inversion algorithm, an image retargeting algorithm, an image completion algorithm, an image summarization algorithm, or the like.

In accordance with the present invention, an image processing algorithm or method may include, on a per-patch basis; for example: computing a property of content of an image patch; and based on the property of the content of the image patch, defining a search region (e.g., a search radius around the image patch) in which the algorithm is to search for similar patches, which may then be used for denoising purposes or for other image processing or image enhancement purposes. Optionally, the algorithm may selectively determine, on a per-patch basis, based on the computed property of the content of the image patch, whether to utilize internal search for similar patches within that image (e.g., in an adaptive search radius or search region), and/or an external search for similar patches in an external image database.

The present invention may be implemented, for example, as a stand-alone application which may be operable on a computer or computing device or electronic device; as a built-in or integrated feature of an electronic device (e.g., a digital camera, a smartphone, a scanner); as an add-on or plug-in or filter or extension which may be installed and/or added to an existing device or to an existing image processing application (e.g., Adobe Photoshop) or an application which may be utilized in solving computer vision problems (e.g., a MATLAB-based application), or the like.

In accordance with the present invention, for example, in order to find an equally good external representative patch for all the patches of a given image, a large external database (e.g., of hundreds or thousands of images) may be required to be processed. Furthermore, internal statistics may have stronger predictive power than external statistics, and may thus give rise to more powerful image-specific priors.

In accordance with the present invention, utilizing internal statistics may have advantages in terms of low memory and computation demands. Additionally, utilizing internal image-specific statistics may often be more powerful than utilizing general external image statistics. For example, given a patch extracted from an image, it may almost surely recur again in the same image; however, such patch may not appear in another image. In order to find equally good external representatives for all image patches of a single image, an external database of hundreds of images may be required, and such a large collection may be computationally infeasible or inefficient to search or process. Moreover, patches extracted from a natural image may tend to recur much more frequently (densely) inside the same image than in any random collection of natural images. This may hold true even for very detailed patches (e.g., a patch of high gradient content), which may contain the most important image details. In addition, the predictive power of internal image-specific statistics may often be stronger than the predictive power of general external statistics. It is further noted that patch recurrences within a single image may be characterized by a long-tailed distribution, and therefore, conventional compact representations of patches may not be able to capture well the full richness of single-image statistics.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” or “a plurality” as used herein include, for example, “multiple” or “two or more”. For example, “a plurality of items” includes two or more items.

Some embodiments may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the machine-readable or computer-readable or device-readable medium may be or may include an electronic, magnetic, optical, electromagnetic, InfraRed (IR), or semiconductor system (or apparatus or device) or a propagation medium. Some demonstrative examples of a computer-readable medium may include a semiconductor or solid state memory, magnetic tape, a removable computer diskette, a Random Access Memory (RAM), a Read-Only Memory (ROM), a rigid magnetic disk, an optical disk, or the like. Some demonstrative examples of optical disks include Compact Disk-Read-Only Memory (CD-ROM), Compact Disk-Read/Write (CD-R/W), DVD, or the like.

In some embodiments, a data processing system suitable for storing and/or executing program code may include at least one processor or controller or circuitry which may be coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices or components (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Some embodiments may be implemented by software, by hardware, or by any combination of software and/or hardware as may be suitable for specific applications or in accordance with specific design requirements. Some embodiments may include units and/or sub-units, which may be separate of each other or combined together, in whole or in part, and may be implemented using specific, multi-purpose or general processors or controllers. Some embodiments may include buffers, registers, stacks, storage units and/or memory units, for temporary or long-term storage of data or in order to facilitate the operation of particular implementations.

Some embodiments may be implemented, for example, using a machine-readable medium or article which may store an instruction or a set of instructions that, if executed by a machine, cause the machine to perform a method and/or operations described herein. Such machine may include, for example, any suitable processing platform, computing platform, computing device, processing device, electronic device, electronic system, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments of the present invention have been illustrated and described herein, many modifications, substitutions, changes, and equivalents may occur to those skilled in the art. Accordingly, the claims are intended to cover all such modifications, substitutions, changes, and equivalents.

What is claimed is:

1. A method of image processing implementable on an electronic device, the method comprising:
calculating for an image patch within an image at least one patch-dependent content information;
based on said at least one patch-dependent content information, determining a patch-dependent search region;
searching said patch-dependent search region for one or more image patches that are similar to said image patch; and
processing said image patch based on said similar image patches found in said patch-dependent search region.

2. The method of claim 1, wherein said patch-dependent search region comprises a confined region around said image patch.

3. The method of claim 1, wherein said patch-dependent search region comprises an external database of images.

4. The method of claim 1, wherein said patch-dependent search region comprises at least one of:
a circular region around said image patch,
a square region around said image patch,
a rectangular region around said image patch,
an elliptical region around said image patch, and
a polygonal region around said image patch.

5. The method of claim 1, wherein said patch-dependent search region is determined based on pre-computed internal image statistics of natural image patches and said patch-dependent content information.

6. The method of claim 5, wherein said pre-computed internal image statistics quantify a typical property of recurrence of a natural image patch inside a natural image.

7. The method of claim 6, wherein said typical property of recurrence comprises at least one of:
a rate of decay of recurrence of natural image patches within an image,
a density of natural image patches,
a degree of occurrence of natural image patches,
a number of similar patches to a natural image patch,
average behavior of a plurality of natural image patches having similar patch-dependent content information,
statistical distribution of natural image patches inside an image, and
non-uniform distribution of natural image patches inside an image.

8. The method of claim 6, wherein said typical property of recurrence is quantified by utilizing at least one of:
an empirically computed lookup table of said typical property,
a parametric expression of said typical property,
a polynomial expression of said typical property,
an exponential expression of said typical property, and
an analytical expression of said typical property.

9. The method of claim 1, wherein said determining comprises a function of at least one of:
a spatial distance from said image patch,
a spatial directional distance from said image patch,
a spatial scale of said image,
a complexity of said image patch,
content of said image patch,
gradients of said image patch,
one or more directional derivatives of said image patch,
a variance of said image patch,
a Laplacian parameter of said image patch,
a descriptor of said image patch,
a local image descriptor of said image, and
a signal-to-noise ratio within said image patch.

10. The method of claim 6, wherein said typical property of recurrence is a function of at least one of:
a spatial distance from said natural image patch,
a spatial directional distance from said natural image patch,
a spatial scale of said natural image,
a complexity of said natural image patch,
content of said natural image patch,
gradients of said natural image patch,
one or more directional derivatives of said natural image patch,
a variance of said natural image patch,
a Laplacian parameter of said natural image patch,
a descriptor of said natural image patch, and
a local image descriptor of said natural image.

11. The method of claim 1, comprising:
limiting an internal patch-dependent search region, for patches similar to a low-gradient image patch, to a close vicinity of said low-gradient image patch within said image.

12. The method of claim 1, comprising:
applying on a low-gradient image patch an internal search within said image for similar patches; and
applying on a high-gradient image patch an external search in an external image database for similar patches.

13. The method of claim 12, comprising:
if a gradient content of said image patch is high, then increasing a size of said external image database to be searched in said external search.

14. The method of claim 1, wherein said patch-dependent content information comprises at least one of:
a mean gradient magnitude of said image patch,
a patch variance,
a patch descriptor,
a SIFT patch descriptor,
a local self-similarity patch descriptor,
one or more patch colors,
distribution of gradients in said image patch,
distribution of colors in said image patch, and
a signal-to-noise ratio within said image patch.

15. The method of claim 1, wherein said image processing comprises performing at least one of:
image denoising,
super resolution,
image summarization,
image saliency,
image completion, and
image retargeting.

16. The method of claim 1, wherein searching said patch-dependent search region for one or more image patches that are similar to said image patch comprises:
measuring patch similarity by taking into account at least one of: normalized correlation, Lp-norm, mutual information, Sum of Square Differences (SSD), and mean-square-error.

17. The method of claim 1, wherein processing said image patch comprises:
generating a new image patch from said one or more similar image patches found in said patch-dependent search region; and said image processing comprises reconstructing a new image from one or more said generated new image patches.

18. The method of claim 17, wherein said generating a new image patch comprises at least one of:
averaging of a plurality of said similar patches;
weighted averaging of a plurality of said similar patches;
computing a median of a plurality of said similar patches;
performing SVD of a plurality of said similar patches;
performing fusion of a plurality of said similar patches;
applying an operator to a plurality of said similar patches; and
performing Principal Component Analysis (PCA) of a plurality of said similar patches.

19. The method of claim 17, wherein said reconstructing a new image comprises at least one of:
replacing said image patch with said generated new image patch;
replacing part of said image patch with part of said generated new image patch;
replacing a center pixel of said patch with the center pixel of said generated new image patch;
averaging overlapping regions of generated new image patches; and
superimposing overlapping regions of generated new image patches.

20. The method of claim 1, wherein the method is implementable on an electronic device selected from the group consisting of:
a desktop computer,
a portable computing device,
a stand-alone digital camera,
a smartphone comprising a digital camera,
a cellular phone comprising a digital camera, and
an image scanner.
